(19) United States
(12) Patent Application Publication
(10) Pub. No.: US 2025/0192629 A1
(43) Pub. Date: Jun. 12, 2025

(54) ROTOR AND ROTARY ELECTRIC MACHINE

(71) Applicant: NIDEC CORPORATION, Kyoto-shi, Kyoto (JP)

(72) Inventor: Yabo HU, Kyoto (JP)

(21) Appl. No.: 18/842,143

(22) PCT Filed: Mar. 2, 2023
(86) PCT No.: PCT/JP2023/007874

§ 371 Date: Aug. 28, 2024

(30) Foreign Application Priority Data
Mar. 4, 2022 (JP) 2022-033654

(51) Int. Cl. H02K 1/278

(52) U.S. Cl. CPC H02K 1/278

(57) ABSTRACT

A rotor is provided in a rotary electric machine, is opposed to a stator, and rotatable about a central axis. The rotor includes magnetic pole portions arranged along a circumferential direction about the central axis, and a rotor core that supports the magnetic pole portions from a radial side. The magnetic pole portions include a main magnet in which a radial direction is a magnetization direction, and sub magnets arranged symmetrically with each other on a circumferential outside of the main magnet, sub magnets in which a direction inclined circumferentially with respect to a radial direction being a magnetization direction. The rotor core includes a recess portion that accommodates a main magnet supported portion facing radially inward of the main magnet and is recessed radially inward.

### CROSS-REFERENCE TO RELATED APPLICATIONS

This is a U.S. national stage of application No. PCT/JP2023/007874, filed on Mar. 2, 2023, with priority under 35 U.S.C. § 119 (a) and 35 U.S.C. § 365 (b) being claimed from Japanese Patent Application No. 2022-033654, filed on Mar. 4, 2022, the disclosures of which are hereby incorporated herein by reference.

### 1. FIELD OF THE INVENTION

The present disclosure relates to rotors and rotary electric machines.

### 2. BACKGROUND

A motor in which drive torque is increased by arranging magnets of a rotor in a Halbach array is known.

In the conventional rotor, one magnetic pole is provided with two sub magnets. The magnetization direction of each sub magnet is not a complete circumferential direction but is inclined in a radial direction. When the magnetic pole having such a configuration is adopted, the magnetization direction is inclined with respect to the outer shape of the sub magnet, and there is a problem of an increase in the manufacturing cost of the sub magnet. Furthermore, in a case of a motor of the Halbach array, it is difficult to increase a radial thickness of the main magnet, and it is difficult to improve the torque as a rotary electric machine. Moreover, there is a case where a gap is generated between the main magnet and the sub magnet due to dimensional tolerance of the main magnet and the sub magnet, and in that case, a permeance coefficient of the magnet is lowered, and there is a possibility that torque is lowered.

### SUMMARY

A rotor of one example embodiment of the present disclosure is a rotor that is provided in a rotary electric machine, is opposed to a stator, and is rotatable about a central axis, the rotor including magnetic pole portions arranged along a circumferential direction about the central axis, and a rotor core that supports the magnetic pole portions from a radial side, in which the magnetic pole portions include a main magnet in which a radial direction is a magnetization direction, and sub magnets arranged symmetrically with each other on a circumferential outside of the main magnet, sub magnets in which a direction inclined circumferentially with respect to a radial direction is a magnetization direction, and the rotor core includes a recess portion to accommodate a main magnet supported portion facing radially inward of the main magnet and is recessed radially inward.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic cross-sectional view in a cross-section along a central axis of a rotary electric machine according to an example embodiment of the present disclosure.

FIG. 2 is a plan view of a rotor according to an example embodiment of the present disclosure.

FIG. 3 is an enlarged view of a main part of the rotor illustrated in FIG. 2.

FIG. 4 is a view illustrating a relationship between a maximum width ratio of a main magnet and a sub magnet and an induced voltage.

### DETAILED DESCRIPTION

In the following description, an axial direction of a central axis J, that is, a direction parallel to an up-down direction is simply called “axial”, a radial direction about the central axis J is simply called “radial”, and a circumferential direction about the central axis J is simply called “circumferential”. In the present example embodiment, a lower side (−Z) corresponds to an axial other side, and an upper side (+Z) corresponds to an axial one side. Note that the up-down direction, the upper side, and the lower side simply are names for describing a relative positional relationship of each portion, and an actual arrangement relationship or the like may be an arrangement relationship other than the arrangement relationships indicated by these names.

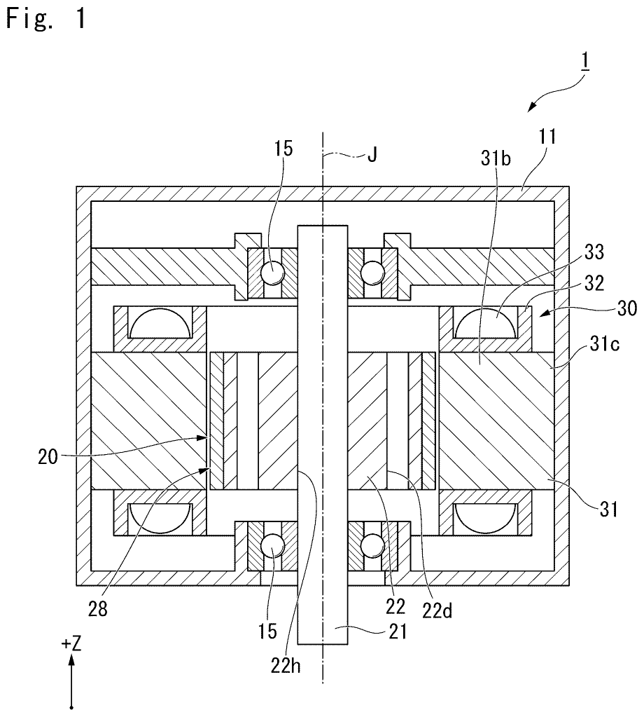

FIG. 1 is a schematic cross-sectional view of a rotary electric machine 1 in a cross-section along the central axis J.

The rotary electric machine 1 of the present example embodiment includes a rotor 20, a stator 30, a plurality of bearings 15, and a housing 11 that accommodates them. The bearing 15 rotatably supports a shaft 21 of the rotor 20. The bearing 15 is held by the housing 11.

The rotary electric machine 1 of the present example embodiment is an inner rotor type rotary electric machine in which the rotor 20 is disposed radially inside the stator 30. In the example embodiment described below, the radial inside is assumed to be radial side, and the radial outside is assumed to be the radial other side. However, the rotary electric machine may be an outer rotor type in which the rotor is disposed radially outside the stator. In this case, the rotary electric machine has a configuration in which the radial side and other side are reversed in each portion of the rotor.

The stator 30 has an annular shape about the central axis J. The rotor 20 is disposed radially inside the stator 30. The stator 30 is radially opposed to the rotor 20.

The stator 30 includes a stator core 31, an insulator 32, and a plurality of coils 33. The stator core 31 includes a plurality of magnetic members stacked along the axial direction.

The stator core 31 includes a core back 31c having a substantially circular shape and a plurality of teeth 31b. In the present example embodiment, the core back 31c has an annular shape about the central axis J. The teeth 31b extend radially inward from a radially inner surface of the core back 31c. An outer peripheral surface of the core back 31c is fixed with an inner peripheral surface of a peripheral wall portion of the housing 11. The plurality of teeth 31b are arranged at intervals from each other in the circumferential direction on the radially inner surface of the core back 31c. In the present example embodiment, the plurality of teeth 31b are arrayed at equal intervals in the circumferential direction.

The insulator 32 is mounted to the stator core 31. The insulator 32 includes a portion covering the teeth 31b. The material for the insulator 32 is an insulating material such as a resin, for example.

The coil 33 is attached to the stator core 31. The plurality of coils 33 are mounted to the stator core 31 with the insulator 32 interposed therebetween. The plurality of coils 33 are configured by winding a conductive wire around each of the teeth 31b with the insulator 32 interposed therebetween.

The rotor 20 is provided in the rotary electric machine 1 and opposed to the stator 30. The rotor 20 rotates about the central axis J. The rotor 20 includes the shaft 21, a rotor core 22, and a plurality of (eight in the present example embodiment) magnetic pole portions 28 arranged along a circumferential direction on an outer peripheral surface of the rotor core 22. Note that the rotor 20 may further include a cover member having a tubular shape surrounding the entire rotor 20 from the radial outside.

The shaft 21 has a cylindrical shape axially extending about the central axis J. The shaft 21 is rotatably supported by a pair of the bearings 15.

The rotor core 22h as a columnar shape extending axially along the central axis J. The rotor core 22h as a substantially polygonal shape as viewed from the axial direction. The rotor core 22 is made of a ferromagnetic material. The rotor core 22 of the present example embodiment includes a plurality of magnetic members stacked along the axial direction.

The rotor core 22 is provided with a central hole 22h and a lightening hole portion 22d that penetrate axially. The central hole 22h is positioned at the center of the rotor core 22 as viewed from the axial direction. The shaft 21 is inserted into and fixed to the central hole 22h. The lightening hole portion 22d is provided to lighten the rotor core 22 to reduce the weight of the rotor core 22.

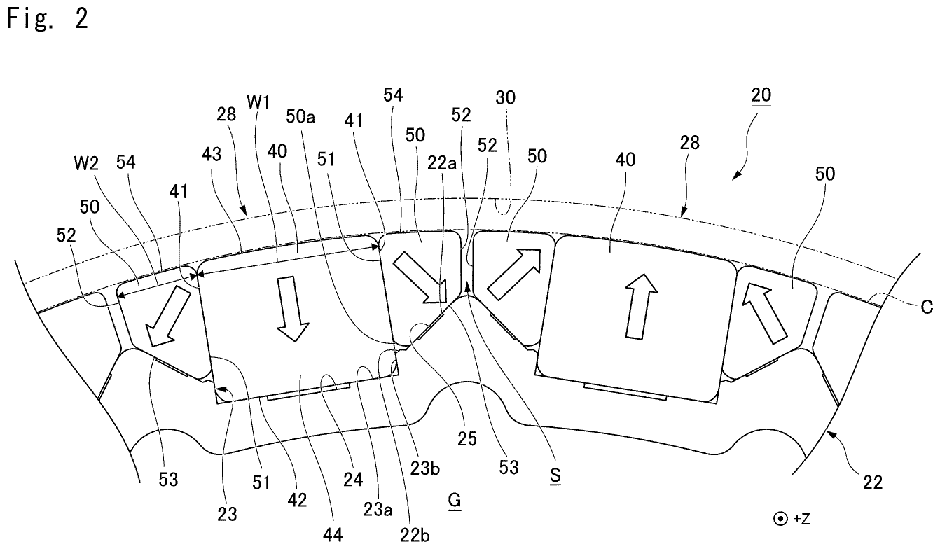

FIG. 2 is a plan view illustrating a part of the rotor 20.

The rotor 20 of the present example embodiment is a surface permanent magnet (SPM) rotor. A main magnet 40 and a sub magnet 50 constituting the magnetic pole portion 28 are bonded and fixed to an outer peripheral surface facing radially outward of the rotor core 22. Due to this, the rotor core 22 supports the plurality of magnetic pole portions 28 from radially inside.

The rotor 20 includes the plurality of (20 in the present example embodiment) magnetic pole portions 28. The plurality of magnetic pole portions 28 are arranged along the circumferential direction about the central axis J. The plurality of magnetic pole portions 28 are arranged at equal intervals along the circumferential direction. The magnetic pole portions 28 circumferentially adjacent to each other have magnetic flux directions inverted from each other in the radial direction. That is, in the magnetic pole portions 28 arranged circumferentially, those with the N poles facing radially outward and those with the S poles facing radially outward are alternately arranged along the circumferential direction.

One magnetic pole portion 28 includes one main magnet 40 and two sub magnets 50. The sub magnets 50 are arranged symmetrically on the circumferential outside of the main magnet 40. Therefore, the sub magnets 50 of the different magnetic pole portions 28 are arranged adjacent to each other at a boundary part between the magnetic pole portions 28 circumferentially adjacent to each other. In the rotor 20, two sub magnets 50 are disposed between a pair of the main magnets 40.

The main magnet 40 and the sub magnet 50 each have a uniform cross-section and extend in a columnar shape along the axial direction of the central axis J. The upper surfaces of the main magnet 40 and the sub magnet 50 form substantially an identical plane. Similarly, the lower surfaces of the main magnet 40 and the sub magnet 50 form substantially an identical plane.

In the main magnet 40, the radial direction is the magnetization direction. In the sub magnet 50, on the other hand, a direction circumferentially inclined with respect to the radial direction is the magnetization direction. As described above, in one magnetic pole portion 28, the pair of sub magnets 50 are symmetrically disposed on the circumferential outside with respect to the main magnet 40. Therefore, the magnetization directions of the pair of sub magnets 50 are symmetrical to each other with respect to the main magnet 40.

In FIG. 2, arrows illustrated in the main magnet 40 and the sub magnet 50 represent magnetization directions of the respective magnets. As illustrated in FIG. 2, the main magnets 40 of the magnetic pole portions 28 circumferentially adjacent to each other have magnetization directions different from each other inside and outside in the radial direction. That is, in the magnetic pole portions 28 circumferentially adjacent to each other, the magnetization directions of the main magnets 40 are inverted from each other. In the sub magnet 50 disposed on the circumferential outside of the main magnet 40 in which the radial outside is the magnetization direction, a direction toward the radial outside as approaching the main magnet 40 is a magnetization direction. In the sub magnet 50 disposed on the circumferential outside of the main magnet 40 in which the radial inside is the magnetization direction, a direction toward the radial inside as away from the main magnet 40 is a magnetization direction. In this manner, the main magnet 40 and the sub magnet 50 constituting each of the magnetic pole portions 28 are arranged in a Halbach array.

In a magnetic pole having an array of magnets generally called a Halbach array, the magnetization direction of a sub magnet is a circumferential direction. On the other hand, in the magnetic pole portion 28 of the present example embodiment, the magnetization direction of the sub magnet 50 is radially inclined with respect to the complete circumferential direction. The magnetization direction of the sub magnet 50 is within a range of about 45°±5° with respect to the radial direction. As described above, by radially inclining the magnetization direction of the sub magnet 50, the magnetic field formed radially outside from the outer peripheral surface of the main magnet 40 can be strengthened as compared with the case where the magnetization direction is the complete circumferential direction, and the power of the rotary electric machine 1 can be increased.

The main magnet 40 has a substantially rectangular shape as viewed from the axial direction. The main magnet 40 includes four side surfaces 41, 41, 42, and 43 extending along the axial direction. That is, the main magnet 40 includes a pair of main magnet side surfaces 41 facing the circumferential direction, a main magnet supported surface 42 facing radially inward, and a main magnet opposed surface 43 facing the radial outside. Among the four side surfaces 41, 41, 42, and 43 of the main magnet 40, the pair of main magnet side surfaces 41 and the main magnet supported surface 42 are flat surfaces. The main magnet 40 includes ae main magnet supported portion 44 including the main magnet supported surface 42. The main magnet supported portion 44 is a region having a predetermined thickness dimension radially outward from the main magnet supported surface 42 with a thickness along the radial direction of the main magnet 40, and is a portion supported in a state of being fitted to the rotor core 22.

The pair of main magnet side surfaces 41 face opposite sides to each other in the circumferential direction. That is, each of the main magnet side surfaces 41 faces circumferentially outward with respect to the main magnet 40. The main magnet side surface 41 is a flat surface extending along the radial direction.

The pair of main magnet side surfaces 41 of the present example embodiment are parallel to each other. Therefore, the main magnet side surfaces 41 are slightly inclined with respect to the radial direction. Note that the main magnet side surfaces 41 may be flat surfaces that completely coincide with the radial direction.

The main magnet supported surface 42 is a flat surface orthogonal to the radial direction. The main magnet supported surface 42 is opposed to, comes into contact with, and is supported by the rotor core 22. The rotor core 22h as a recess portion 23 accommodating the main magnet supported portion 44 and recessed radially inward.

The recess portion 23 includes a first support surface 23a positioned at a recess bottom and a pair of second support surfaces 23b opposed to each other in the circumferential direction. The recess portion 23 has substantially the same shape as the main magnet supported portion 44 as viewed from the axial direction, and extends with the same shape along the axial direction. That is, the circumferential length of the first support surface 23a is substantially equal to the circumferential length of the main magnet supported surface 42. The distance between the pair of second support surfaces 23b is also substantially equal to the circumferential length of the main magnet supported surface 42. The first support surface 23a is opposed to and comes into contact with the main magnet supported surface 42.

The second support surface 23b circumferentially supports the main magnet side surface 41. The first support surface 23a is provided with a first groove 24 recessed radially inward. The first groove 24 is filled with an adhesive. Therefore, the main magnet supported surface 42 is fixed to the first support surface 23a via the adhesive filled in the first groove 24. Due to this, the main magnet 40 is fixed to the rotor core 22 in a state where the main magnet supported portion 44 is fitted and accommodated in the recess portion 23.

The main magnet opposed surface 43 is opposed to the stator 30. The main magnet opposed surface 43 is a gentle curved surface having a constant: distance to the central axis J. Therefore, the thickness dimension along the radial direction of the main magnet 40 is the largest at the circumferential center and decreases toward circumferential both sides. In the present example embodiment, the main magnet opposed surface 43 is an arc surface having a constant curvature radius.

Here, as illustrated in FIG. 2, an imaginary circle C connecting outer peripheral ends of the main magnet opposed surfaces 43 of the plurality of main magnets 40 is assumed. The imaginary circle C is an imaginary circle about the central axis J. The main magnet opposed surface 43 is inscribed in the imaginary circle C at the circumferential center.

Note that in FIG. 2, the imaginary circle C is drawn slightly away from the main magnet 40 and the sub magnet 50 for the sake of visibility, but is actually inscribed.

The main magnet opposed surface 43 of the present example embodiment is an arc surface having a curvature radius smaller than the radius of the imaginary circle C. Therefore, the magnetic flux density of the magnetic field formed radially outward from the main magnet opposed surface 43 can be increased at the circumferential center of the main magnet opposed surface 43. This can increase the drive torque of the rotor 20 and the output of the rotary electric machine 1.

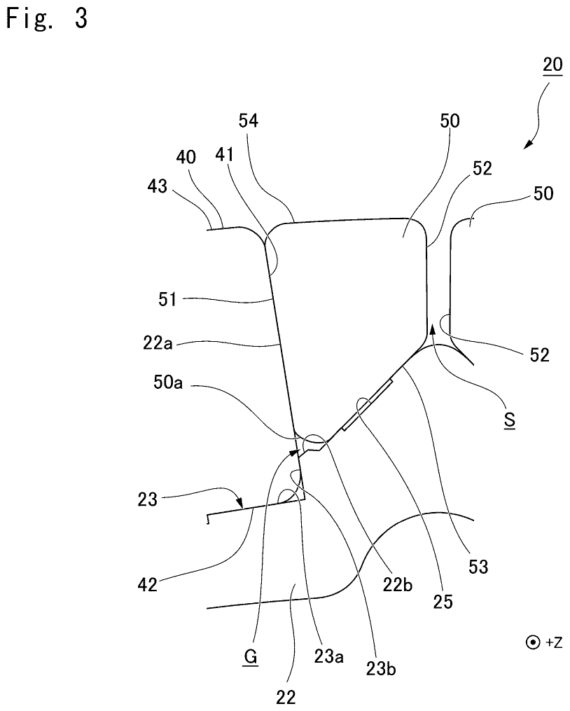

As illustrated in FIG. 3, the sub magnet 50 has a substantially rectangular shape as viewed from the axial direction. The sub magnet 50 includes four side surfaces 51, 52, 53, and 54 extending along the axial direction. That is, the sub magnet 50 includes a first side surface 51, a second side surface 52, a third side surface 53, and a sub magnet opposed surface 54 (fourth side surface). The four side surfaces 51, 52, 53, and 54 of the sub magnet 50 are all flat surfaces. The four corner portions of the sub magnet 50 are each formed in a tapered shape or an arc shape and do not have a vertex.

The first side surface 51 is a flat surface extending along the radial direction and facing the circumferential direction. The first side surface 51 is opposed to and comes into contact with the main magnet side surface 41 in the circumferential direction. That is, the sub magnet 50 comes into contact with the main magnet 40 on the first side surface 51.

The second side surface 52 faces the opposite side of the first side surface 51 in the circumferential direction. The second side surface 52 extends along the radial direction. The second side surface 52 is a surface substantially parallel to the first side surface 51.

The third side surface 53 is a flat surface connecting the first side surface 51 and the second side surface 52 on the radial inside as viewed from the axial direction. The third side surface 53 faces radially outward and faces the opposite side of the first side surface 51 in the circumferential direction. The third side surface 53 faces the rotor core 22 side in the radial direction (i.e., radial inside). The third side surface 53 is inclined radially outward toward the circumferential outside. That is, the first side surface 51 and the third side surface 53 are arranged in a wedge shape so as to approach each other toward the radial inside, and are connected at a predetermined inclination angle with a corner portion 50a as a top part.

The third side surface 53 is opposed to, comes into contact with, and is supported by the rotor core 22. The rotor core 22h as a third support surface 22a supporting the third side surface 53. The third support surface 22a is inclined radially outward toward the circumferential outside. The third support surface 22a is provided with a second groove 25 (groove portion) recessed radially inward. The second groove 25 is filled with an adhesive. Therefore, the third side surface 53 is fixed to the third support surface 22a via the adhesive filled in the second groove 25. Thus, the sub magnet 50 is fixed to the rotor core 22.

A pair of the third support surfaces 22a opposed to the respective third side surfaces 53 of the sub magnets 50 circumferentially adjacent to each other in the rotor core 22 are arranged in a mountain shape protruding radially outward as circumferentially approaching each other. In the sub magnets 50 circumferentially adjacent to each other, the second side surfaces 52 opposed to each other are circumferentially separated from each other. That is, gaps S are provided between the respective sub magnets 50 at circumferential intervals.

The rotor core 22 includes a fourth support surface 22b connecting the second support surface 23b and the third support surface 22a. The corner portion 50a formed by the first side surface 51 and the third side surface 53 is opposed to the fourth support surface 22b via the gap G along the radial direction.

The sub magnet opposed surface 54 connects the first side surface 51 and the second side surface 52 on the radially outside and faces the direction outside. The sub magnet opposed surface 54 is opposed to the stator 30. The sub magnet opposed surface 54 is a flat surface extending along a plane orthogonal to the radial direction.

The sub magnet opposed surface 54 is inscribed in the imaginary circle C. That is, in the present example embodiment, the main magnet opposed surface 43 and the sub magnet opposed surface 54 are inscribed in the imaginary circle C that is common. Due to this, the gap dimension between the main magnet 40 and the stator 30 and the gap dimension between the sub magnet 50 and the stator 30 can be identical. This can bring both the main magnet 40 and the sub magnet 50 as close as possible to the stator 30, and increase the output of the rotary electric machine 1.

In the present example embodiment, the sub magnet opposed surface 54 is a flat surface orthogonal to the radial direction. Since the sub magnet opposed surface 54 is a flat surface, the sub magnet opposed surface 54 can be formed by plane polishing in the manufacturing process of the sub magnet 50, and the dimensional accuracy of the sub magnet opposed surface 54 can be easily improved. By making the sub magnet opposed surface 54 a surface orthogonal to the radial direction, it is easy to make the sub magnet opposed surface 54 a surface inscribed in the imaginary circle C. That is, according to the present example embodiment, it is easy to form the sub magnet opposed surface 54 inscribed in the imaginary circle C.

As illustrated in FIG. 2, in the main magnet 40, the maximum width dimension in a direction orthogonal to the radial direction positioned at the circumferential center is a main magnet maximum width W1. In the sub magnet 50, the maximum width dimension in a direction orthogonal to the first side surface 51 is a sub magnet maximum width W2. At this time, the ratio of the main magnet maximum width W1 to the sub magnet maximum width W2 (main magnet maximum width W1/sub magnet maximum width W2) is preferably in a range of equal to or greater than about 1.2 and equal to or less than about 3.2. This ratio is also called a maximum width ratio W1/W2 hereinafter.

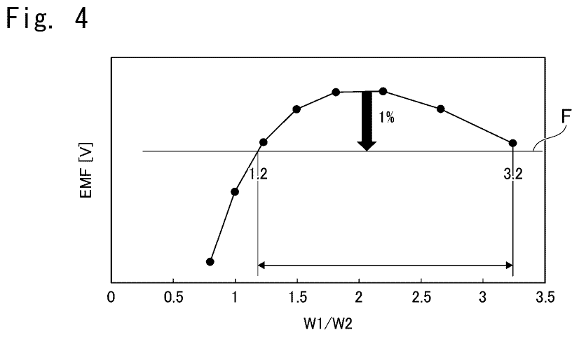

FIG. 4 is a view illustrating a relationship between the maximum width ratio W1/W2 of the main magnet and the sub magnet and an induced voltage EMF (V). FIG. 4 is a curve in which the induced voltages EMF of eight cases where the maximum width ratio W1/W2 is changed in a range of approximately 0.5 to 3.5 are plotted. The induced voltage EMF has a maximum peak value when the maximum width ratio W1/W2 is in the range of 1.8 to 2.2, and decreases when the maximum width ratio W1/W2 exceeds 2.2. Here, the rotor 20 having the magnets arranged in the Halbach array in the rotary electric machine 1 is preferable because the induced voltage EMF falls within a range of decrease by 1% from the peak value, whereby the back electromotive force is large and the rotor can be rotated with large torque. A line with reference sign F illustrated in FIG. 4 indicates a position where the induced voltage EMF has decreased by 1% from the peak value. That is, the maximum width ratio W1/W2 is in a range of equal to or greater than about 1.2 and equal to or less than about 3.2 in which the induced voltage EMF is in a region of equal to or greater than the line F (hereinafter, called a 1% decrease line). In this range, the lower limit value 1.2 is an intersection between the curve of the induced voltage EMF and the 1% decrease line F, and the upper limit value 3.2 is the largest maximum width ratio W1/W2 among the eight cases in the region of equal to or greater than the 1% decrease line.

According to the present example embodiment, the main magnet 40 is assembled antecedently by being fitted into the recess portion 23 of the rotor core 22 from the radial outside without any gap. Due to this, the main magnet 40 is positioned in a predetermined posture with respect to the rotor core 22. At this time, the magnet supported surface 42 of the main magnet 40 comes into contact with the first support surface 23a positioned on the bottom surface of the recess portion 23 in a state of being opposed to the first support surface 23a. Since the recess portion 23 is provided with the second support surface 23b, the main magnet supported portion 44 of the main magnet 40 that is assembled is supported in a state where circumferential movement is restricted by the second support surface 23b.

Next, the sub magnet 50 is assembled between the main magnet side surface 41 of the main magnet 40 and the third support surface 22a of the rotor core 22 so as to be inserted from the radial outside. That is, the first side surface 51 of the sub magnet 50 is opposed to and brought into contact with the main magnet side surface 41 of the main magnet 40 assembled antecedently, and the third side surface 53 is opposed to and brought into contact with the third support surface 22a of the rotor core 22, whereby the sub magnet 50 can be assembled to the rotor core 22. Due to this, in the present example embodiment, regardless of the circumferential dimensional tolerance of the main magnet 40 and the sub magnet 50, the sub magnet 50 and the main magnet 40 as well as the sub magnet 50 and the rotor core 22 can be reliably brought into contact with each other.

The sub magnet 50 is provided for reducing the magnetic resistance by configuring the shortest magnetic path between the main magnets 40 arranged circumferentially in the rotor 20. According to the present example embodiment, by bringing the first side surface 51 of the sub magnet 50 into contact with the main magnet 40, it is possible to cause the magnetic path to directly pass through between the sub magnet 50 and the main magnet 40, and it is possible to suppress an increase in magnetic resistance as compared with a case provided with a void. By bringing the third side surface 53 of the sub magnet 50 into contact with the rotor core 22, it is possible to cause the magnetic path to circumferentially pass through via the rotor core 22 between the magnetic pole portions 28 adjacent circumferentially. This can reduce the magnetic resistance between the sub magnets 50 adjacent circumferentially. That is, according to the present example embodiment, the magnetic resistance of the magnetic path passing through the rotor 20 can be suppressed without extremely increasing the dimensional accuracy of the main magnet 40 and the sub magnet 50. This can strengthen the magnetic field formed radially outside the rotor 20, and can configure the rotary electric machine 1 having high output.

According to the present example embodiment, since the main magnet 40 is configured to be fitted into the recess portion 23 of the rotor core 22, the thickness dimension (thickness) along the radial direction of the main magnet 40 can be increased. That is, the main magnet 40 can have a shape in which the length dimension along the radial direction of the main magnet side surface 41 is increased. Therefore, a large contact area between the first side surface 51 and the main magnet side surface 41 can be secured. This can further reduce the magnetic resistance of the magnetic path passing through the rotor 20.

In the present example embodiment, the rotor core 22 includes the recess portion 23 accommodating the main magnet supported portion 44 facing radially inward of the main magnet 40 and recessed radially inward. Therefore, by fitting, into the recess portion 23, a part (main magnet supported portion 44) of the radial inside of the main magnet 40 to be assembled antecedently, it is possible to accurately position the main magnet 40, and it is possible to accurately position the sub magnet 50 with respect to the main magnet side surface 41 and the third support surface 22a of the rotor core 22, which are accurately positioned. As described above, in the rotor 20 according to the present example embodiment, the thickness of the main magnet 40 can be increased, and furthermore, by assembling the main magnet 40 and the sub magnet 50 without a gap, the permeance of the magnet can be increased, and the torque can be improved to increase the output of the rotary electric machine 1.

According to the present example embodiment, the main magnet 40 can be easily positioned at the time of assembly only by work of fitting the main magnet 40 into the recess portion 23 of the rotor core 22. That is, a dedicated positioning jig used at the time of assembly of the rotor 20 becomes unnecessary, and work efficiency required for the assembly can be improved. Therefore, the assembly process of the rotor 20 can be simplified, and the manufacturing cost of the rotor 20 having magnets arranged in the Halbach array can be reduced.

According to the present example embodiment, the third side surface 53 is a flat surface orthogonal to the magnetization direction of the sub magnet 50. In a general magnet, a magnet (hereinafter, material magnet) mass-produced in advance is polished into a desired shape for each product and used. The material magnet before polishing is formed in a quadrangular prism shape. The material magnet before polishing is magnetized in a direction orthogonal to the plane direction of the quadrangular prism due to ease of magnetization and the like. According to the sub magnet 50 of the present example embodiment, since the third side surface 53 is orthogonal to the magnetization direction, a part of the outer shape of the material magnet can be used as the third side surface 53 in the manufacturing process of the sub magnet 50.

The rotor core 22 of the present example embodiment includes the fourth support surface 22b connecting the second support surface 23b supporting the main magnet side surface 42 and the third support surface 22a supporting the third side surface 53 of the sub magnet 50. The corner portion 50a formed by the first side surface 51 and the third side surface 53 is radially opposed to the fourth support surface 22b with the gap G interposed therebetween. Due to this, in the present example embodiment, the corner portion 50a of the sub magnet 50 is positioned away from and not brought into contact with the fourth support surface 22b of the rotor core 22, and thus the sub magnet 50 can be accurately positioned regardless of the dimensional tolerance of the sub magnet 50. That is, assembly can be performed in a state where the first side surface 51 of the sub magnet 50 is reliably brought into contact with the main magnet side surface 41 and the third side surface 53 is reliably brought into contact with the third support surface 22a. As described above, in the present example embodiment, since the dimensional tolerance (processing accuracy) of the sub magnet 50 and an error at the time of assembly can be allowed within the range of the gap G, the sub magnet 50 with respect to the main magnet 40 after assembly can be accurately positioned, and the quality accuracy can be improved.

In the present example embodiment, the maximum width ratio W1/W2 of the main magnet maximum width W1 to the sub magnet maximum width W2 is in the range of equal to or greater than about 1.2 and equal to or less than about 3.2. Due to this, the induced voltage EMF falls within a range of 1% decrease from the peak value, the back electromotive force is large, and rotation can be performed with large torque. Therefore, high performance can be exhibited as the rotary electric machine 1 including the rotor 20 having the magnets arranged in a Halbach array.

The third support surface 22a of the rotor core 22 of the present example embodiment includes the second groove 25. An adhesive is filled between the second groove 25 and the third side surface 53. Due to this, the third side surface 53 of the sub magnet 50 can be reliably fixed to the third support surface 22a via the adhesive filled in the second groove 25.

In the present example embodiment, the magnetization direction of the sub magnet 50 is within a range of about 45°±5° with respect to the radial direction. That is, according to the present example embodiment, the magnetization direction of the main magnet 40 is a radial direction, and the magnetization direction of the sub magnet 50 arranged circumferentially outside the main magnet 40 is within the range of about 45°±5°. This can effectively strengthen the magnetic field formed on the radial outside by the magnetic pole portion 28 configured by these main magnets 40 and the pair of sub magnets 50, and can increase the output of the rotary electric machine 1.

While the example embodiment of the present disclosure and the modifications thereof have been described above, the respective configurations and combinations thereof in the example embodiment and the modifications are merely examples, and addition, omission, substitution, and other variations of the configurations can be made within the scope not departing from the gist of the present disclosure. The present disclosure is not to be limited by the example embodiment and the modifications thereof.

For example, the shapes of the magnets and the shapes of the outer cores are not limited to the examples described in the above-described example embodiment and modifications. The number of poles of the rotor and the number of slots of the stator are not limited to those of the above-described example embodiment.

In the above-described example embodiment and the modifications thereof, a case where the present disclosure is applied to a surface permanent magnet (SPM) rotor has been described. However, the present disclosure may be applied to an interior permanent magnet (IPM) rotor.

The rotary electric machine applied with the present disclosure is not limited to a motor, and may be a generator. The purpose of the rotary electric machine is not particularly limited. The rotary electric machine is not particularly limited in terms of posture in use.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9. (canceled)

10. A rotor that is provided in a rotary electric machine, is opposed to a stator, and is rotatable about a central axis, the rotor comprising:
magnetic pole portions arranged along a circumferential direction about the central axis; and
a rotor core that supports the magnetic pole portions from a radial side; wherein the magnetic pole portions include:
a main magnet in which a radial direction is a magnetization direction; and
sub magnets arranged symmetrically with each other on a circumferential outside of the main magnet, sub magnets in which a direction inclined
circumferentially with respect to a radial direction being a magnetization direction; and
the rotor core includes a recess portion that accommodates a main magnet supported portion facing radially inward of the main magnet and is recessed radially inward.

11. The rotor according to claim 10, wherein
the main magnet includes:
a main magnet supported surface facing radially inward; and
a pair of main magnet side surfaces facing circumferentially outward;
the sub magnet includes:
a first side surface opposed to and in contact with the main magnet side surface in a circumferential direction;
a second side surface opposing an opposite side of the first side surface in a circumferential direction; and
a third side surface connecting the first side surface and the second side surface on a radial inside as viewed from an axial direction;
the rotor core includes:
a first support surface supporting the main magnet supported surface;
a second support surface opposed to a circumferential direction of the recess portion and supporting the main magnet side surface;
a third support surface supporting the third side surface; and
a fourth support surface connecting the second support surface and the third support surface; and
a corner portion defined by the first side surface and the third side surface is opposed to the fourth support surface across a gap.

12. The rotor according to claim 11, wherein in the main magnet, a maximum width dimension in a direction orthogonal to a radial direction positioned at a circumferential center is a main magnet maximum width, and in the sub magnet, when a maximum width dimension in a direction orthogonal to the first side surface is a sub magnet maximum width, a ratio of the main magnet maximum width to the sub magnet maximum width is in a range of equal to or greater than about 1.2 and equal to or less than about 3.2.

13. The rotor according to claim 11, wherein the third support surface of the rotor core includes a groove portion in which an adhesive is filled between the groove portion and the third side surface.

14. The rotor according to claim 11, wherein the second side surface is a flat surface orthogonal to a magnetization direction of the sub magnet.

15. The rotor according to claim 11, wherein a magnetization direction of the sub magnet is within a range of about 45°±5° with respect to a radial direction.

16. The rotor according to claim 10, wherein
the main magnet includes a main magnet opposed surface facing radially outward and opposed to the stator;
the sub magnet includes a sub magnet opposed surface facing radially outward and opposed to the stator; and
the main magnet opposed surface and the sub magnet opposed surface are inscribed in an imaginary circle about the central axis.

17. The rotor according to claim 16, wherein
the main magnet opposed surface is an arc surface having a curvature radius smaller than a radius of the imaginary circle; and
the sub magnet opposed surface is a flat surface extending along a plane orthogonal to a radial direction.

18. A rotary electric machine comprising:
the rotor according to claim 10; and
a stator opposed to the rotor.
